(19) United States
(12) Patent Application Publication
(10) Pub. No.: US 2016/0198756 A1
(43) Pub. Date: Jul. 14, 2016

(54) Method of Pascalizing Foodstuffs Using a Blockless High Pressure Processing Machine

(71) Applicant: Adrian Staruszkiewicz, Oviedo, FL (US)

(72) Inventor: Adrian Staruszkiewicz, Oviedo, FL (US)

(21) Appl. No.: 14/994,019

(22) Filed: Jan. 12, 2016

Related U.S. Application Data
(60) Provisional application No. 62/102,361, filed on Jan. 12, 2015.

(51) Int. Cl. A23L 3/015; A23L 3/00

(52) U.S. Cl. CPC A23L 3/0155; A23L 3/001; A23V 2002/00

(57) ABSTRACT

A method of pascalizing foodstuffs using a blockless high pressure processing (HPP) machine is used to kill bacteria, viruses, molds, etc. in foods in order to extend shelf life without preservatives. In order for the method to be performed, an externally-frame, a tubular shell, a first plug, and a second plug are provided as components of the HPP machine. The tubular shell is used to hold foodstuffs which are to be pascalized. The first plug and the second plug are placed onto either end of the tubular shell to form a pressurable vessel. In order for the pressurable vessel to stay intact during the pascalization process, the pressurable vessel is placed within the externally-bracing frame. As water is pumped into the pressurable vessel, the first plug and the second plug move outward and rest against the externally-bracing frame, instead of blocks which would otherwise be used.

The current application claims a priority to the U.S. Provisional Patent application Ser. No. 62/102,361 filed on Jan. 12, 2015.

### FIELD OF THE INVENTION

The present invention relates generally to methods for pascalizing foods. More specifically, the present invention relates to a method of pascalizing foods with a high pressure processing machine that does not employ the use of blocks to prevent plugs from being ejected under due to high pressures.

### BACKGROUND OF THE INVENTION

High pressure processing (HPP) machines are commonly used to pascalize foods. The process of pascalization is used to kill bacteria, viruses, molds, etc. which can cause foods to spoil. Common HPP machines use plugs to seal a tubular shell so that water may be pumped into the shell by intensifiers. At high pressures, the plugs begin to move outwards from the tubular shell but are stopped by blocks which sit between the plugs and the externally-bracing frame of the HPP machine. While blocks are effective at keeping the plugs inside the tubular shell, the blocks increase the time needed to complete a pascalization process. In an industrial setting, longer processes equate to fewer products being made. Furthermore, with a design that uses blocks, the plugs of HPP machines move within the frame, instead of with the shell. As a result, the lines that connect intensifiers to the plugs can experience twisting and friction against each other.

Accordingly, there is a present need for a method of pascalizing foods which uses a blockless HPP machine. By eliminating blocks from the HPP machine, the HPP machine may be condensed, requiring less space to operate. Additionally, removing blocks can reduce the time of each individual pascalization process because the HPP machine does not need to slide blocks into and out of the frame. Furthermore, because of how the plugs enter and exit the frame, the lines which connect the intensifiers to the plugs experience less twisting, thus elongating the lifespan for each of the lines.

### BRIEF DESCRIPTION OF THE DRAWINGS

FIG. 1 is a schematic diagram depicting a blockless high pressure processing (HPP) machine prior to assembling the pressurable vessel from the tubular shell, the first plug, and the second plug.

FIG. 2 is a schematic diagram depicting a blockless HPP machine with the assembled pressurable vessel.

FIG. 3 is a schematic diagram depicting a blockless HPP machine with the pressurable vessel positioned within the externally-bracing frame.

FIG. 4 is a schematic diagram depicting a blockless HPP machine with first plug and the second plug pressed against the externally-bracing frame.

FIG. 5 is a flowchart describing the general process of the present invention.

FIG. 6 is a flowchart describing the step pumping a pressurizing quantity of water into the pressurable vessel.

FIG. 7 is a flowchart further describing the step pumping a pressurizing quantity of water into the pressurable vessel.

FIG. 8 is a flowchart describing the steps of sizing the length of the stopper for the first plug.

FIG. 9 is a flowchart describing the steps of sizing the length of the stopper for the second plug.

FIG. 10 is a flowchart describing the steps of sizing the length of the cap for the first plug.

FIG. 11 is a flowchart describing the steps of sizing the length of the cap for the second plug.

FIG. 12 is a flowchart describing the steps of sizing the length of the tubular shell.

FIG. 13 is a flowchart further describing the steps of sizing the length of the tubular shell.

FIG. 14 is a flowchart describing the steps of sizing the length between the first internal surface and the second internal surface.

FIG. 15 is a flowchart further describing the steps of sizing the length between the first internal surface and the second internal surface.

### DETAILED DESCRIPTION OF THE INVENTION

All illustrations of the drawings are for the purpose of describing selected versions of the present invention and are not intended to limit the scope of the present invention.

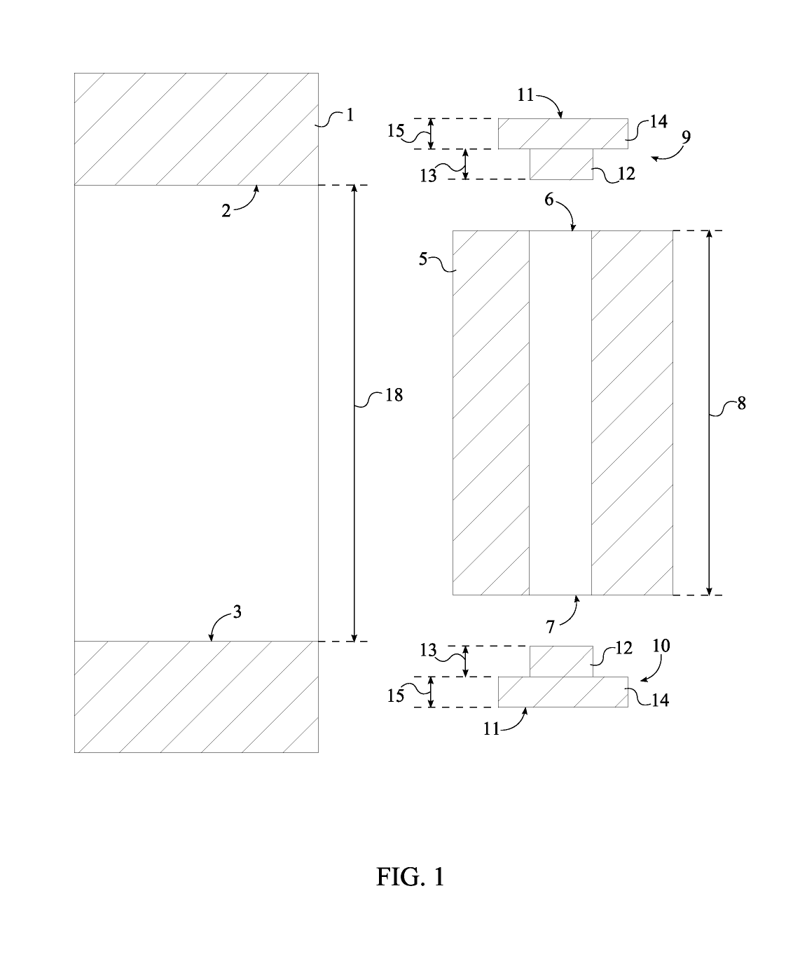

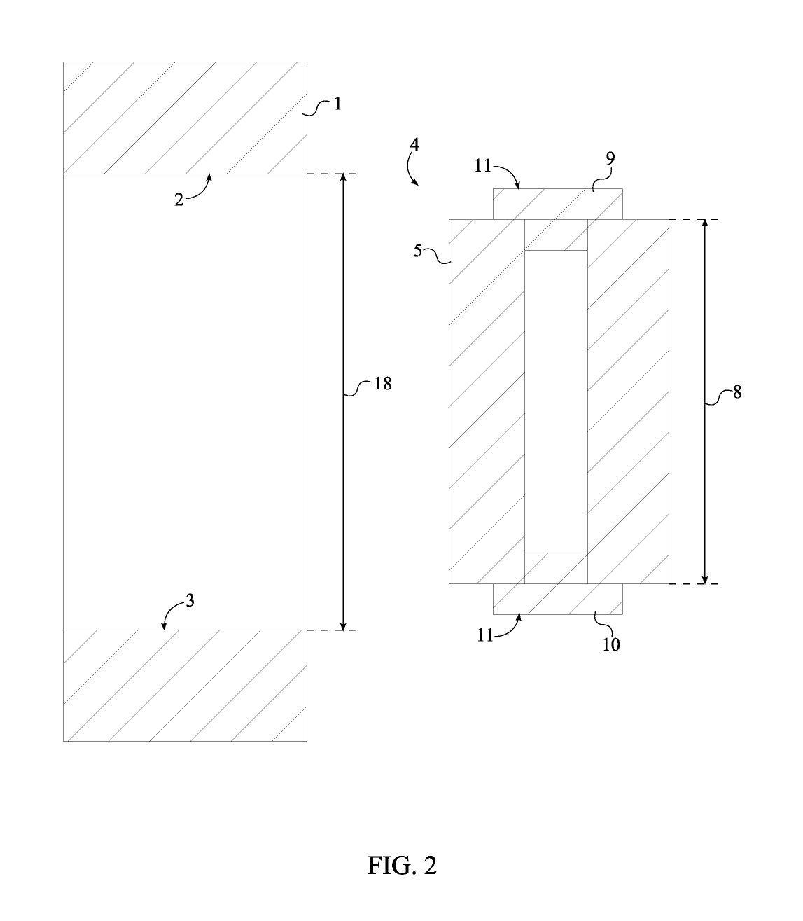

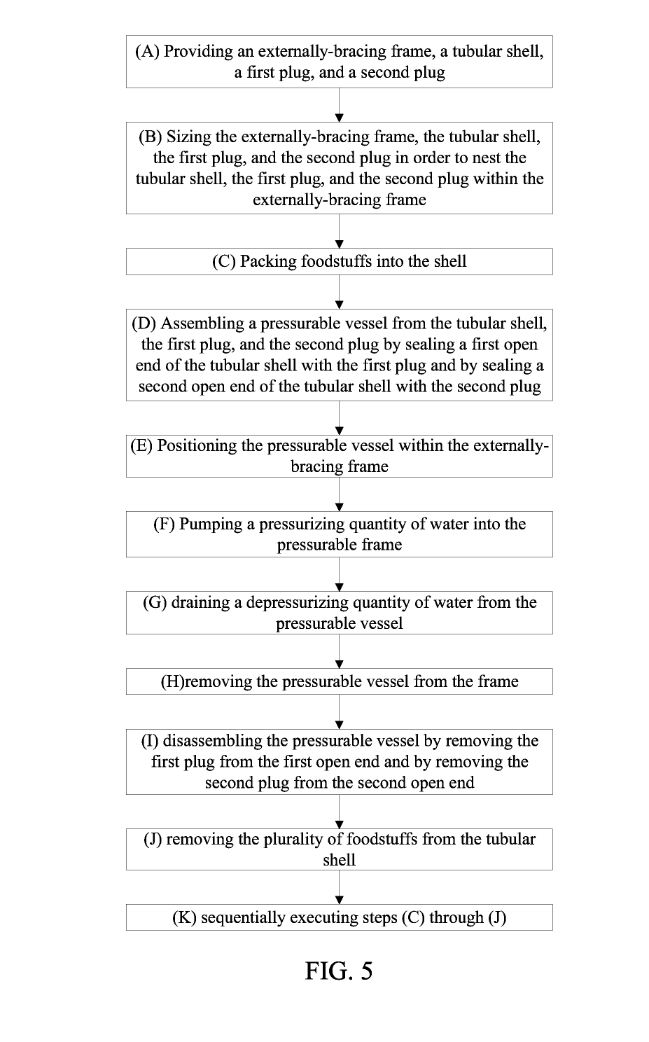

With reference to FIGS. 1-2 and FIG. 5, the present invention is a method of pascalizing foodstuffs using a blockless high pressure processing (HPP) machine. The present invention is used for sterilizing foods to increase shelf life without the need for preservatives. The method of the present invention corresponds with a blockless HPP machine, which is used as an apparatus of the present invention. An externally-bracing frame 1, a tubular shell 5, a first plug 9, and a second plug 10 are provided as components of the HPP machine (Step A). The externally-bracing frame 1, the tubular shell 5, the first plug 9, and the second plug 10 are sized in order to nest the tubular shell 5, the first plug 9 and the second plug 10 within the externally-bracing frame 1 (Step B). Together, the tubular shell 5, the first plug 9 and the second plug 10 are used to encapsulate foodstuffs which are to undergo the pascalization process. The externally-bracing frame 1 is used to prevent the first plug 9 and the second plug 10 from sliding out of the tubular shell 5 during the pascalization process.

In order to pascalize foodstuffs, the foodstuffs are first packed into the shell (Step C). A pressurable vessel 4 is assembled from the tubular shell 5, the first plug 9, and the second plug 10 by sealing a first open end 6 of the tubular shell 5 with the first plug 9 and by sealing a second open end 7 of the tubular shell 5 with the second plug 10 (Step D). The pressurable vessel 4 is used to enclose the foodstuffs as well as water at high pressures. The pressurable vessel 4 is positioned within the externally-bracing frame 1 so that the externally-bracing frame 1 may be used to prevent the pressurable vessel 4 from disassembling due to high pressures (Step E). A pressurizing quantity of water is pumped into the pressurable vessel 4 using intensifiers which are connected to the first plug 9 and the second plug 10 (Step F). Depending on the exact process used, the pressurizing quantity may vary. Similarly, varying processes may require that the foodstuffs be exposed to high pressures for a certain period of time to ensure successful pascalization. After the foodstuffs have been exposed to high pressures for the required amount of time, a depressurizing quantity of water is drained from the pressurable vessel 4 (Step G) and the pressurable vessel 4 is removed from the externally-bracing frame 1 (Step H). At this point, the pressurable vessel 4 is disassembled by removing the first plug 9 from the first open end 6 and by removing the second plug 10 from the second open end 7 (Step I). To conclude the process, the foodstuffs are removed from the tubular shell 5 (Step J). Because the process of the present invention uses a blockless HPP machine, it is necessary that steps (C) through (J) are sequentially executed (Step K).

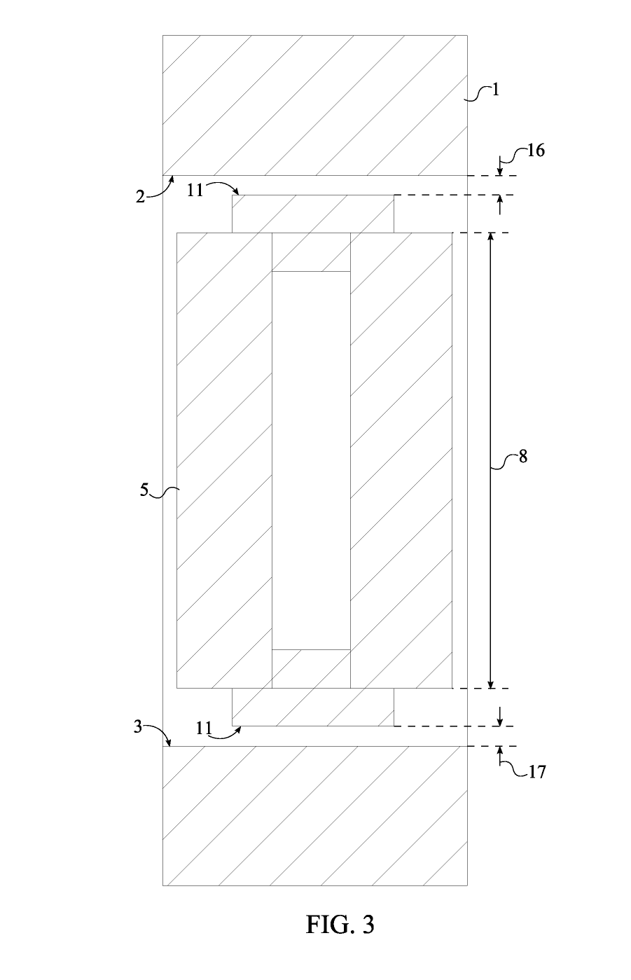

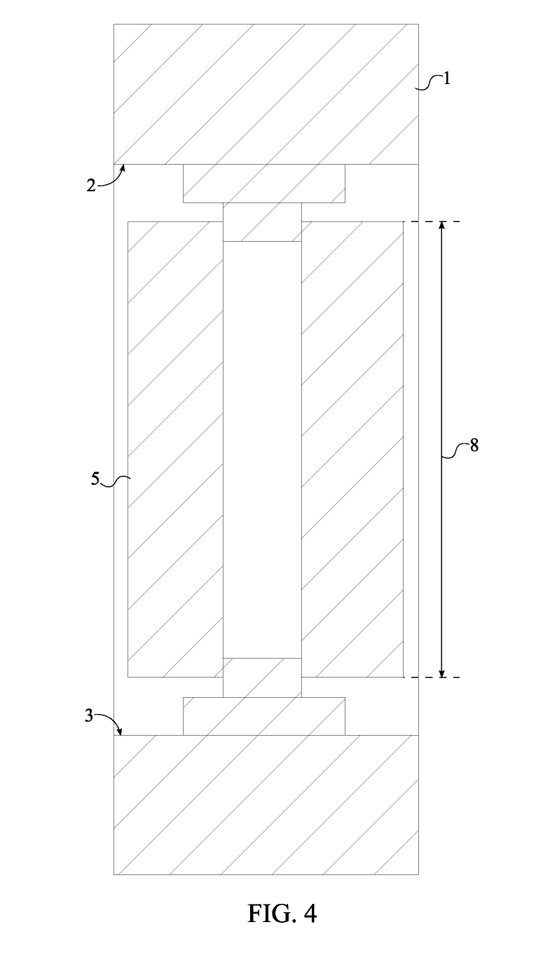

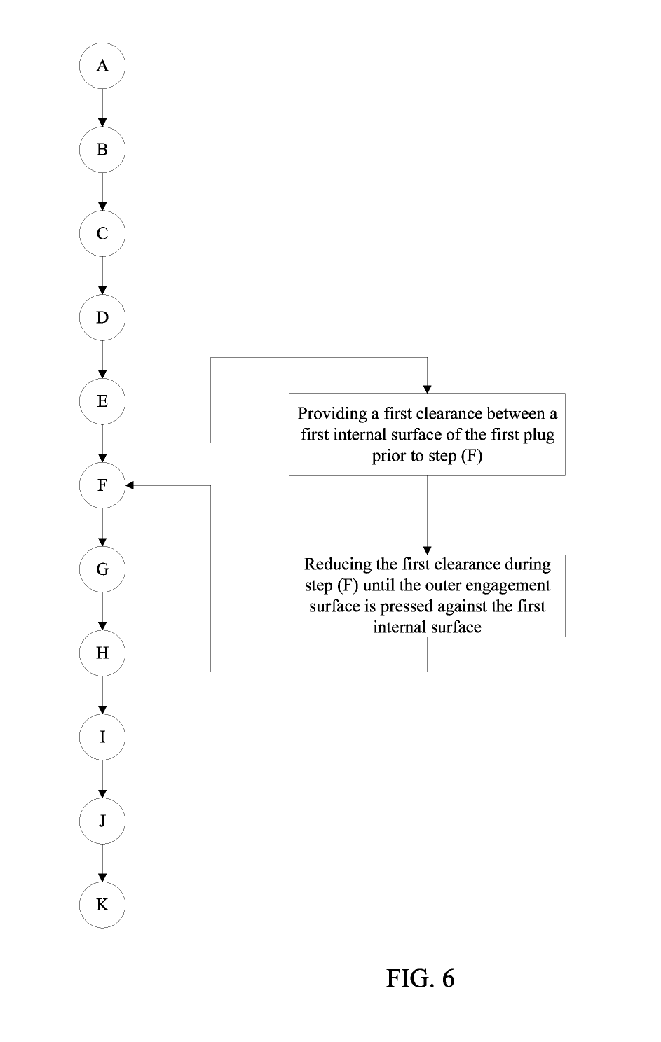

In reference to FIG. 3 and FIG. 6, a first clearance 16 is provided between a first internal surface 2 of the externally-bracing frame 1 and an outer engagement surface 11 of the first plug 9 prior to step (F). The first clearance 16 allows the pressurable vessel 4 to be positioned within the externally-bracing frame 1. Because the first plug 9 is not locked into the tubular shell 5, the first plug 9 is able to slide outward from the tubular shell 5 when the pressurable vessel 4 is pressurized. As a result, the first clearance 16 is reduced during step (F) until the outer engagement surface 11 is pressed against the first internal surface 2. This is shown in FIG. 4. When the first plug 9 is pressed against the first internal surface 2, the first plug 9 is prevented from moving further outward from the tubular shell 5. This stabilizes the pressurable vessel 4 and allows the pressure within the pressurable vessel 4 to increase as needed.

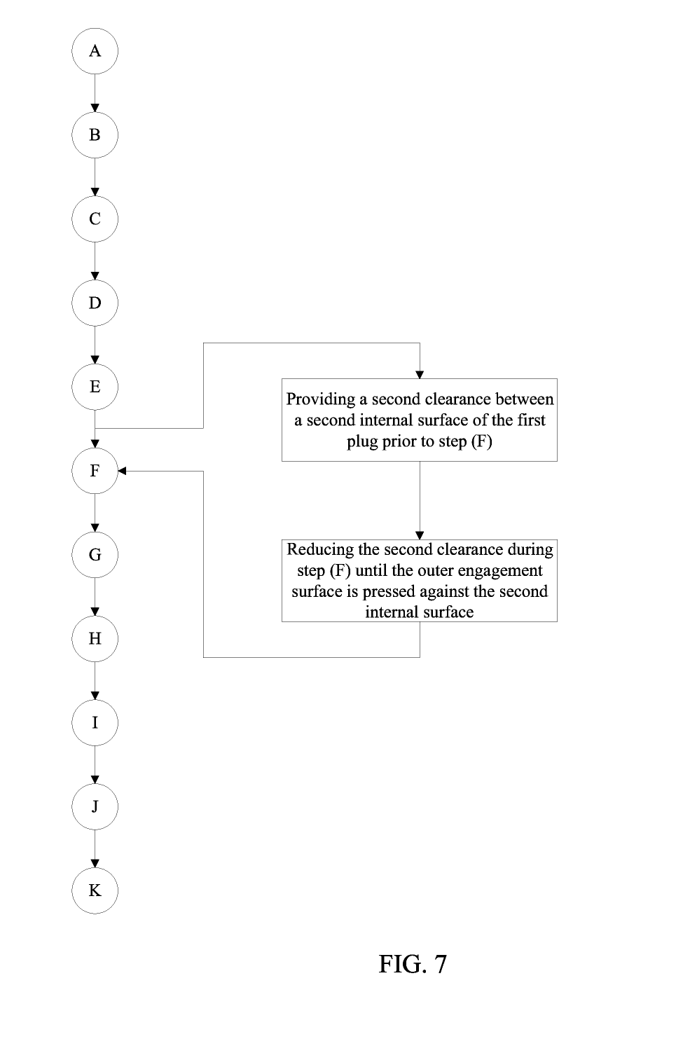

Similarly, a second clearance 17 is provided between a second internal surface 3 of the externally-bracing frame 1 and an outer engagement surface 11 of the second plug 10 prior to step (F). In reference to FIG. 3 and FIG. 7, the second clearance 17 allows the pressurable vessel 4 to be positioned within the externally-bracing frame 1. Because the second plug 10 is not locked into the tubular shell 5, the second plug 10 is able to slide outward from the tubular shell 5 when the pressurable vessel 4 is pressurized. As a result, the second clearance 17 is reduced during step (F) until the outer engagement surface 11 is pressed against the second internal surface 3. This is shown in FIG. 4. When the second plug 10 is pressed against the second internal surface 3, the second plug 10 is prevented from moving further outward from the tubular shell 5. This stabilizes the pressurable vessel 4 and allows the pressure within the pressurable vessel 4 to increase as needed.

Because blocks are not used with the present invention, there is added space between the first plug 9 and the externally-bracing frame 1 that increases the size of the first clearance 16. There is also added space between the second plug 10 and the externally-bracing frame 1 which increases the size of the second clearance 17. In order for the HPP machine to work properly, it is necessary that the first clearance 16 and the second clearance 17 are small enough that the first plug 9 and the second plug 10 are unable to exit the tubular shell 5 during the pascalization process. To account for the space created in the absence of blocks, various components may be sized independently or collaboratively to ensure that the first plug 9 and the second plug 10 remain within the tubular shell 5 during step (F). In reference to FIG. 1, the first plug 9 and the second plug 10 each comprise a stopper 12 and a cap 14. The stopper 12 is positioned through the first open end 6 and into the tubular shell 5 and is used to prevent water from escaping the tubular shell 5. The cap 14 is connected adjacent to the stopper 12, external to the tubular shell 5, and is pressed against the externally-bracing frame 1 during step (F) to prevent the stopper 12 from exiting the tubular shell 5. A length 13 of the stopper 12 and a length 15 of the cap 14 are both parallel to a length 8 of the tubular shell 5. The length 13 of the stopper 12 and the length 15 of the cap 14 may be adjusted to prevent water from escaping the tubular shell 5.

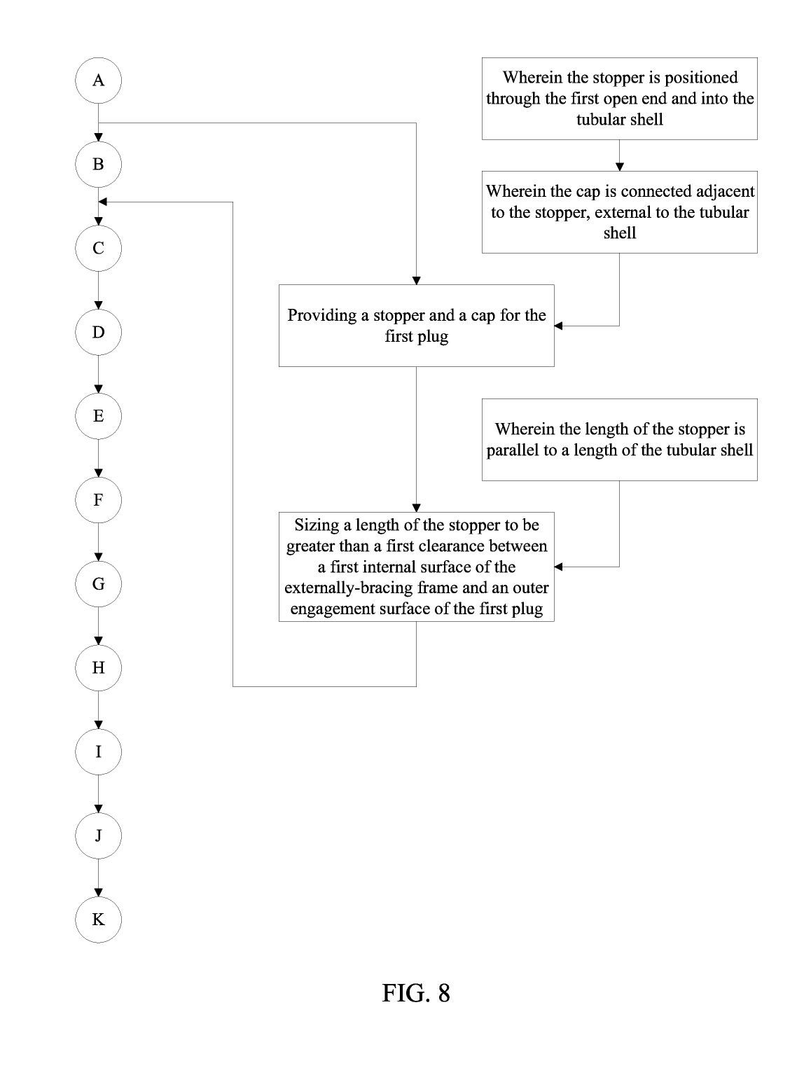

In reference to FIG. 8, one method of accounting for the lack of blocks, involves sizing the stopper 12. Specifically, the length 13 of the stopper 12 is sized to be greater than the first clearance 16 between the first internal surface 2 of the externally-bracing frame 1 and the outer engagement surface 11 of the first plug 9. This is done to ensure that the cap 14 presses against the first internal surface 2 before the stopper 12 is ejected from the tubular shell 5.

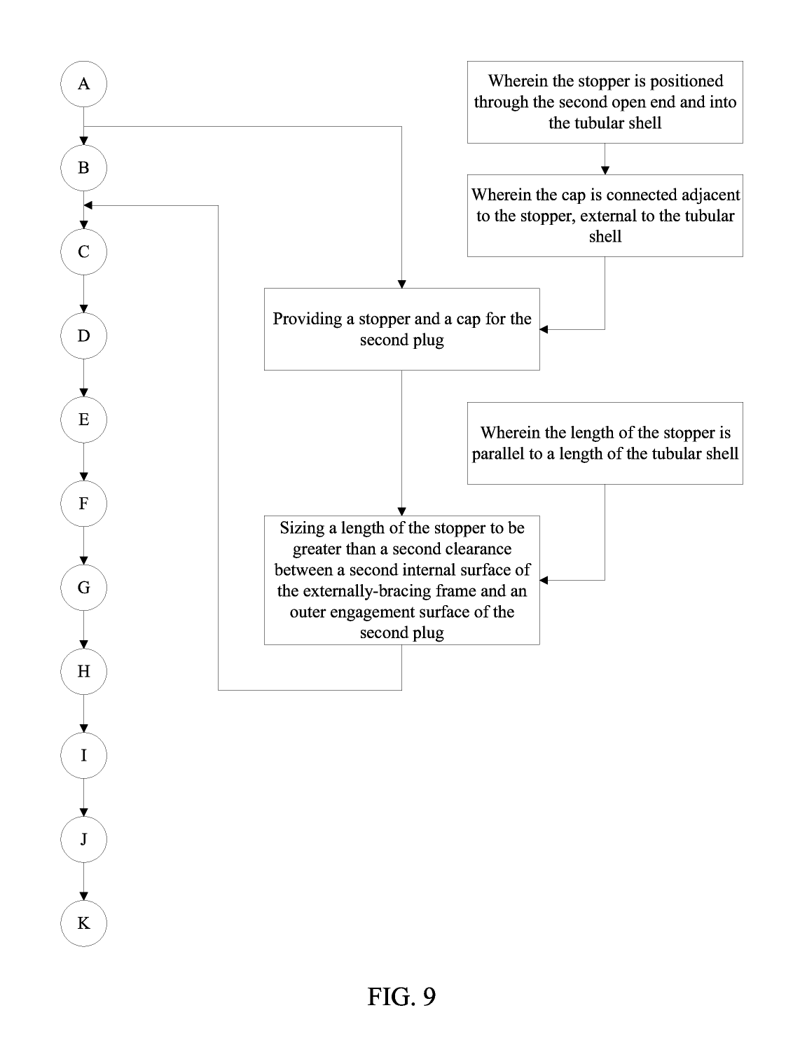

Likewise, in reference to FIG. 9, the length 13 of the stopper 12 is sized to be greater than the second clearance 17 between the second internal surface 3 of the externally-bracing frame 1 and the outer engagement surface 11 of the second plug 10. This is done to ensure that the cap 14 presses against the second internal surface 3 before the stopper 12 is ejected from the tubular shell 5.

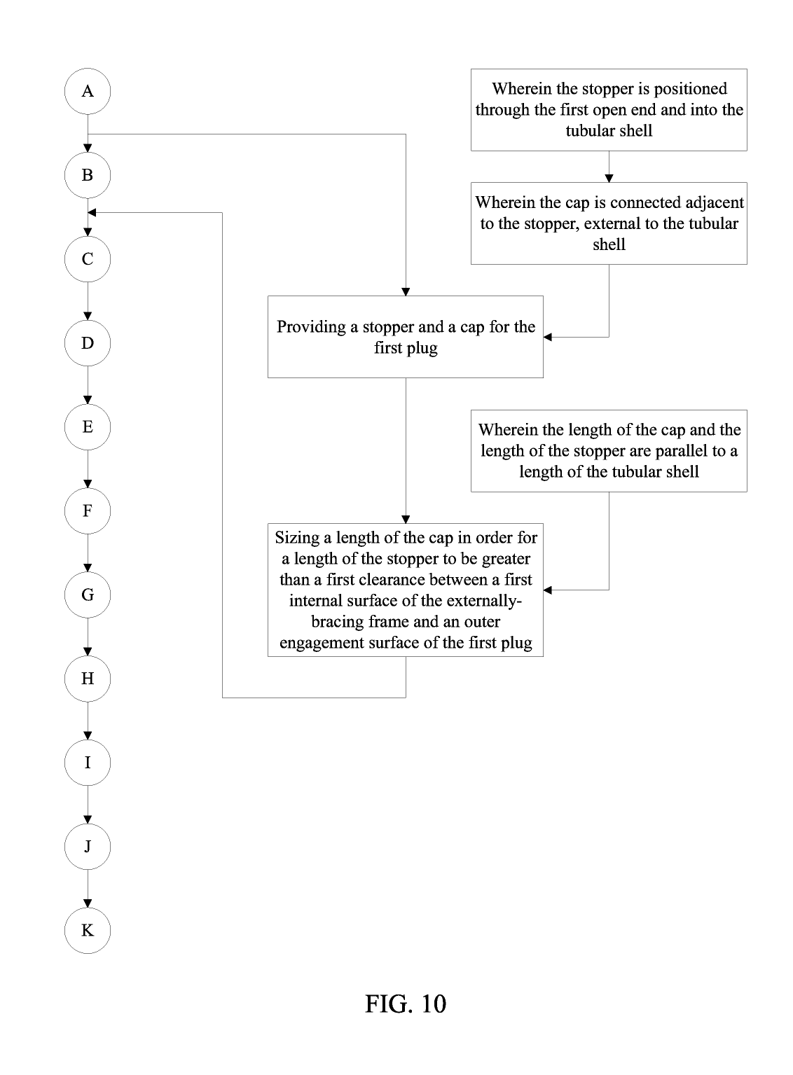

In reference to FIG. 10, another method of accounting for the lack of blocks involves sizing the cap 14. In this method, the length 15 of the cap 14 is sized in order for the length 13 of the stopper 12 to be greater than the first clearance 16 between the first internal surface 2 of the externally-bracing frame 1 and the outer engagement surface 11 of the first plug 9. If the length 15 of the cap 14 is increased enough, the first clearance 16 decreases to the point where the first plug 9 is unable to escape the tubular shell 5.

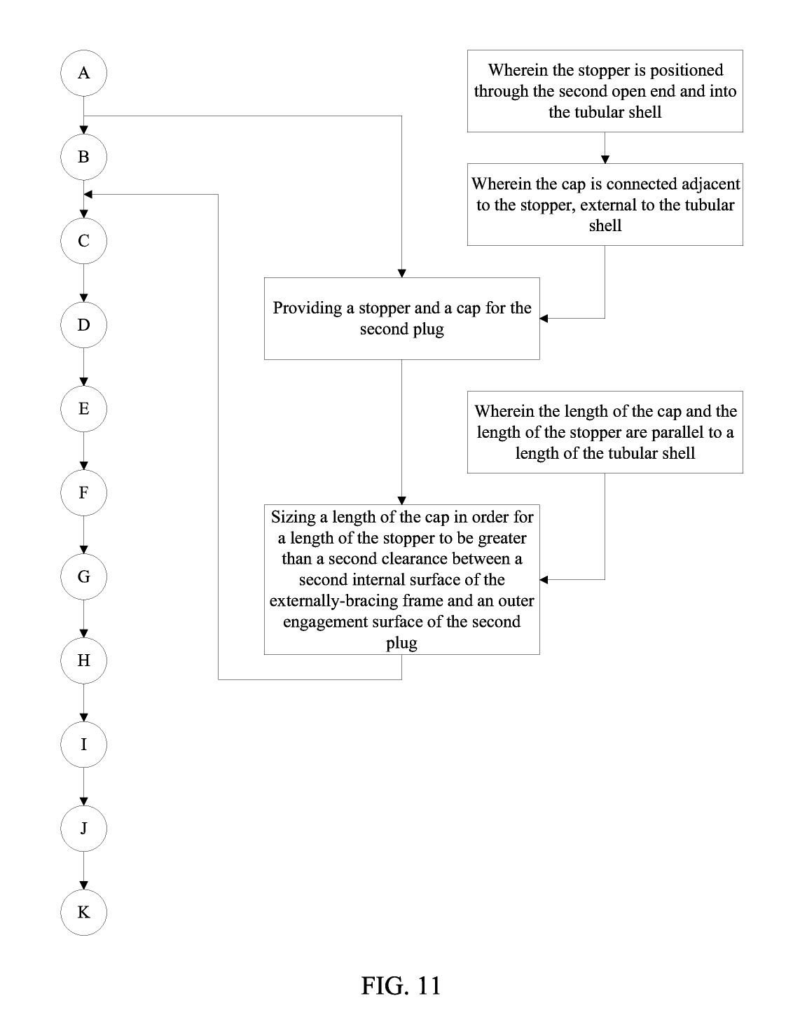

Similarly, in reference to FIG. 11, the length 15 of the cap 14 is sized in order for the length 13 of the stopper 12 to be greater than the second clearance 17 between the second internal surface 3 of the externally-bracing frame 1 and the outer engagement surface 11 of the second plug 10. If the length 15 of the cap 14 is increased enough, the second clearance 17 decreases to the point where the second plug 10 is unable to escape the tubular shell 5.

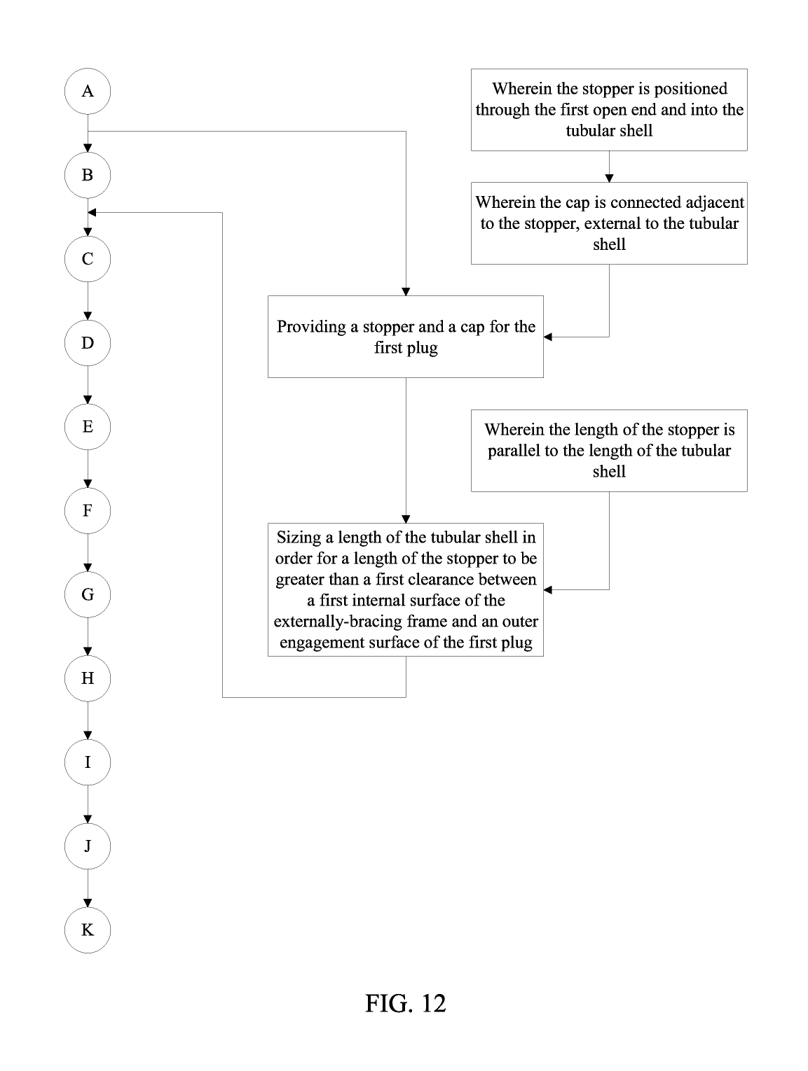

In yet another method of accounting for the lack of blocks, shown in FIG. 12, the length 8 of the tubular shell 5 may be adjusted. The length 8 of the tubular shell 5 is sized in order for the length 13 of the stopper 12 to be greater than the first clearance 16 between the first internal surface 2 of the externally-bracing frame 1 and the outer engagement surface 11 of the first plug 9. If the length 8 of the tubular shell 5 is increased enough, the first clearance 16 decreases to the point where the first plug 9 is unable to escape the tubular shell 5.

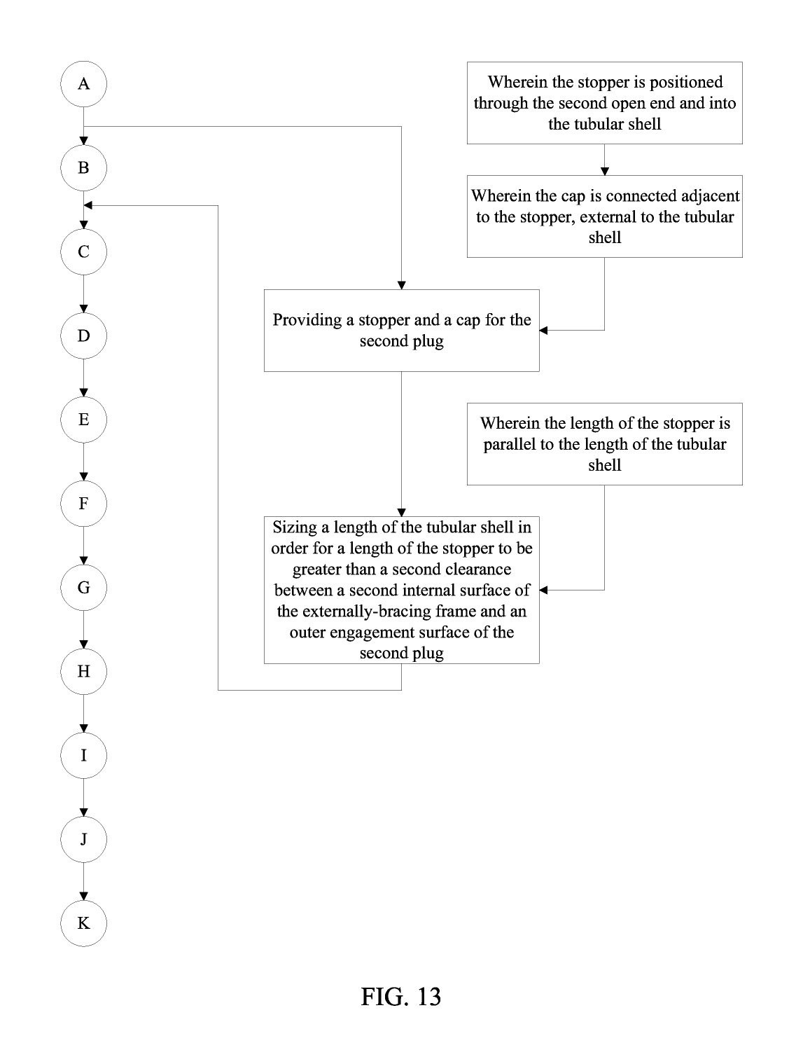

Likewise, in reference to FIG. 13, the length 8 of the tubular shell 5 is sized in order for the length 13 of the stopper 12 to be greater than the second clearance 17 between the second internal surface 3 of the externally-bracing frame 1 and the outer engagement surface 11 of the second plug 10. If the length 8 of the tubular shell 5 is increased enough, the second clearance 17 decreases to the point where the second plug 10 is unable to escape the tubular shell 5.

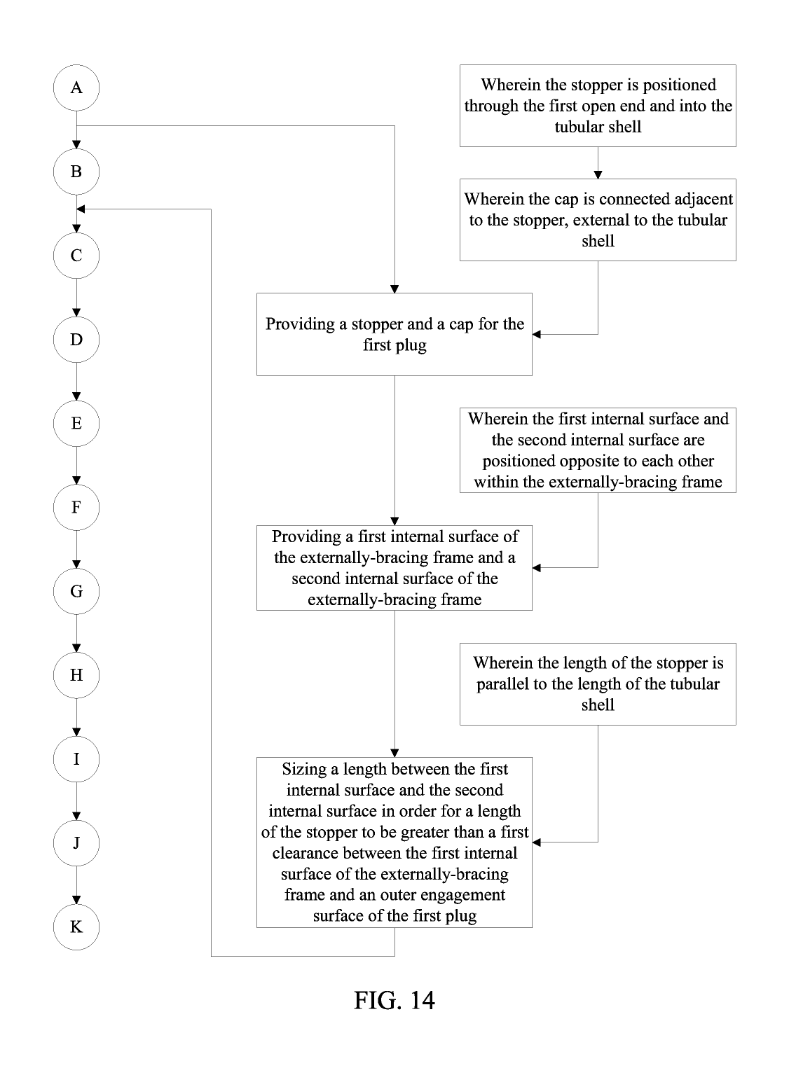

In another method of accounting for the lack of blocks, a length 18 between the first internal surface 2 and the second internal surface 3 is sized in order for the length 13 of the stopper 12 to be greater than the first clearance 16 between the first internal surface 2 of the externally-bracing frame 1 and the outer engagement surface 11 of the first plug 9. This is shown in FIG. 14. The first internal surface 2 and the second internal surface 3 are positioned opposite to each other within the externally-bracing frame 1. Accordingly, if the length 18 between the first internal surface 2 and the second internal surface 3 is decreased enough, the first clearance 16 decreases to the point where the first plug 9 is unable to escape the tubular body.

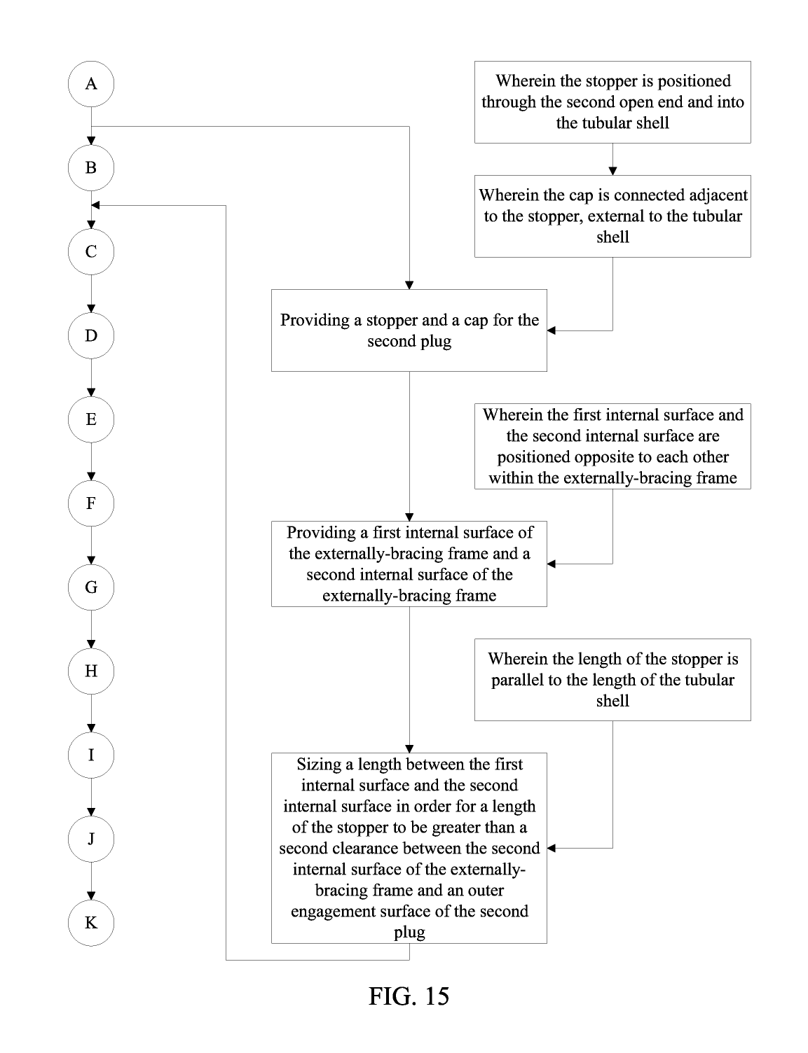

Similarly, in reference to FIG. 15, the length 18 between the first internal surface 2 and the second internal surface 3 is sized in order for the length 13 of the stopper 12 to be greater than the second clearance 17 between the second internal surface 3 of the externally-bracing frame 1 and the outer engagement surface 11 of the second plug 10. If the length 18 between the first internal surface 2 and the second internal surface 3 is decreased enough, the second clearance 17 decreases to the point where the second plug 10 is unable to escape the tubular body.

Although the invention has been explained in relation to its preferred embodiment, it is to be understood that many other possible modifications and variations can be made without departing from the spirit and scope of the invention as hereinafter claimed.

What is claimed is:

1. A method of pascalizing foodstuffs using a blockless high pressure processing (HPP) machine, the method comprises the steps of:
(A) providing an externally-bracing frame, a tubular shell, a first plug, and a second plug;
(B) sizing the externally-bracing frame, the tubular shell, the first plug, and the second plug in order to nest the tubular shell, the first plug, and the second plug within the externally-bracing frame;
(C) packing foodstuffs into the tubular shell;
(D) assembling a pressurable vessel from the tubular shell, the first plug, and the second plug by sealing a first open end of the tubular shell with the first plug and by sealing a second open end of the tubular shell with the second plug;
(E) positioning the pressurable vessel within the externally-bracing frame;
(F) pumping a pressurizing quantity of water into the pressurable vessel;
(G) draining a depressurizing quantity of water from the pressurable vessel;
(H) removing the pressurable vessel from the externally-bracing frame;
(I) disassembling the pressurable vessel by removing the first plug from the first open end and by removing the second plug from the second open end;
(J) removing the foodstuffs from the tubular shell; and
(K) sequentially executing steps (C) through (J).

2. The method of pascalizing foodstuffs using a blockless HPP machine, the method as claimed in claim 1 comprises:
providing a first clearance between a first internal surface of the externally-bracing frame and an outer engagement surface of the first plug prior to step (F); and
reducing the first clearance during step (F) until the outer engagement surface is pressed against the first internal surface.

3. The method of pascalizing foodstuffs using a blockless HPP machine, the method as claimed in claim 1 comprises:
providing a second clearance between a second internal surface of the externally-bracing frame and an outer engagement surface of the second plug prior to step (F); and
reducing the second clearance during step (F) until the outer engagement surface is pressed against the second internal surface.

4. The method of pascalizing foodstuffs using a blockless HPP machine, the method as claimed in claim 1 comprises:
providing a stopper and a cap for the first plug, wherein the stopper is positioned through the first open end and into the tubular shell, and wherein the cap being connected adjacent to the stopper, external to the tubular shell; and
sizing a length of the stopper to be greater than a first clearance between a first internal surface of the externally-bracing frame and an outer engagement surface of the first plug, wherein the length of the stopper is parallel to a length of the tubular shell.

5. The method of pascalizing foodstuffs using a blockless HPP machine, the method as claimed in claim 1 comprises:
providing a stopper and a cap for the second plug, wherein the stopper is positioned through the second open end and into the tubular shell, and wherein the cap being connected adjacent to the stopper, external to the tubular shell; and
sizing a length of the plug stopper to be greater than a second clearance between a second internal surface of the externally-bracing frame and an outer engagement surface of the second plug, wherein the length of the stopper is parallel to a length of the tubular shell.

6. The method of pascalizing foodstuffs using a blockless HPP machine, the method as claimed in claim 1 comprises:
providing a stopper and a cap for the first plug, wherein the stopper is positioned through the first open end and into the tubular shell, and wherein the cap being connected adjacent to the stopper, external to the tubular shell; and
sizing a length of the cap in order for a length of the stopper to be greater than a first clearance between a first internal surface of the externally-bracing frame and an outer engagement surface of the first plug, wherein the length of the cap and the length of the stopper are parallel to a length of the tubular shell.

7. The method of pascalizing foodstuffs using a blockless HPP machine, the method as claimed in claim 1 comprises:
providing a stopper and a cap for the second plug, wherein the stopper is positioned through the second open end and into the tubular shell, and wherein the cap being connected adjacent to the stopper, external to the tubular shell; and
sizing a length of the cap in order for a length of the stopper to be greater than a second clearance between a second internal surface of the externally-bracing frame and an outer engagement surface of the second plug, wherein the length of the cap and the length of the stopper are parallel to a length of the tubular shell.

8. The method of pascalizing foodstuffs using a blockless HPP machine, the method as claimed in claim 1 comprises:
providing a stopper and a cap for the first plug, wherein the stopper is positioned through the first open end and into the tubular shell, and wherein the cap being connected adjacent to the stopper, external to the tubular shell; and
sizing a length of the tubular shell in order for a length of the stopper to be greater than a first clearance between a first internal surface of the externally-bracing frame and an outer engagement surface of the first plug, wherein the length of the stopper is parallel to the length of the tubular shell.

9. The method of pascalizing foodstuffs using a blockless HPP machine, the method as claimed in claim 1 comprises:
providing a stopper and a cap for the second plug, wherein the stopper is positioned through the second open end and into the tubular shell, and wherein the cap being connected adjacent to the stopper, external to the tubular shell; and
sizing a length of the tubular shell in order for a length of the stopper to be greater than a second clearance between a second internal surface of the externally-bracing frame and an outer engagement surface of the second plug, wherein the length of the stopper is parallel to the length of the tubular shell.

10. The method of pascalizing foodstuffs using a blockless HPP machine, the method as claimed in claim 1 comprises:
providing a stopper and a cap for the first plug, wherein the stopper is positioned through the first open end and into the tubular shell, and wherein the cap being connected adjacent to the stopper, external to the tubular shell;
providing a first internal surface of the externally-bracing frame and a second internal surface of the externally-bracing frame, wherein the first internal surface and the second internal surface are positioned opposite to each other within the externally-bracing frame; and
sizing a length between the first internal surface and the second internal surface in order for a length of the stopper to be greater than a first clearance between the first internal surface of the externally-bracing frame and an outer engagement surface of the first plug, wherein the length of the stopper is parallel to a length of the tubular shell.

11. The method of pascalizing foodstuffs using a blockless HPP machine, the method as claimed in claim 1 comprises:
providing a stopper and a cap for the second plug, wherein the stopper is positioned through the second open end and into the tubular shell, and wherein the cap being connected adjacent to the stopper, external to the tubular shell;
providing a first internal surface of the externally-bracing frame and a second internal surface of the externally-bracing frame, wherein the first internal surface and the second internal surface are positioned opposite to each other within the externally-bracing frame; and
sizing a length between the first internal surface and the second internal surface in order for a length of the stopper to be greater than a second clearance between the second internal surface of the externally-bracing frame and an outer engagement surface of the second plug, wherein the length of the stopper is parallel to a length of the tubular shell.
